(19) United States
(12) Patent Application Publication
(10) Pub. No.: US 2006/0097416 A1
(43) Pub. Date: May 11, 2006

(54) Optical element mold and the process for making such

(75) Inventor: Ga-Lane Chen, Fremont, CA (US)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/228,640

(22) Filed: Sep. 16, 2005

(30) Foreign Application Priority Data
Nov. 5, 2004 (TW) 93133747

(51) Int. Cl. B29D 11/00

(52) U.S. Cl. 264/2.5; 249/135; 425/406; 425/808

(57) ABSTRACT

An optical element mold (10) includes a mold base (101) having a surface (102) and a coating layer (103) formed on the surface. The coating layer has a compressive stress created therein. The coating layer is comprised of nano-scale crystalline particles and nano-scale crystalline boundaries. The nano-scale crystalline particles are enclosed and bordered by the nano-scale crystalline boundaries. The coating layer has a thickness in the range from 20 nm to 200 nm. The surface is made of a WC ceramic; and the coating layer is made of a material selected from a group consisting of SiC, Si₃N₄, TiN, BCN and any combination thereof.

### BACKGROUD OF THE PRESENT INVENTION

1. Field of the Invention

The present invention relates to molds for making optical element and a process for making such molds and, particularly, to a mold for making an optical element with a coating layer thereon and a method for making such a mold.

2. Discussion of the Related Art

Many optical elements can be mass produced by a press-molding method. The press-molding method eliminates many complicated steps, such as cutting and polishing processes. However, to obtain an optical element having an excellent optical homogeneity and a mirror surface, a mold having superior surface physical properties is required. A typical method for making such a mold is to deposit one or more functional thin films on the mold, thereby improving the hardness, heat resistance, durability, parting (i.e., mold release) ability and mirror surface workability thereof.

Heretofore, many attempts have been made to develop ideal coatings for application to such molds. For instance, a diamond like carbon (DLC) film coating is advised in U.S. Pat. No. 5,202,156. Such a DLC film coating can provide excellent physical properties due to some of the carbon atoms being organized in an ideal diamond structure. Unfortunately, what can be obtained is far from ideal, in that {111} twins, followed by atom dislocations and {111} atom stacking faults, almost inevitably and wildly/randomly are developed during a chemical vapor deposition process. Unintentional non-carbon elements, such as nitrogen and silicon, may be somehow incorporated into diamond structure during a growth process. Therefore, DLC films on molds cannot be expected to provide a satisfactory performance.

Therefore, what is needed in the art is to provide a satisfactory mold for making an optical element and a related method for making such a mold.

### SUMMARY OF THE INVENTION

The present optical element mold incorporates a new design of thin film coating coated thereon, thus improving the surface physical properties of the mold.

The present optical element mold includes a mold base having a surface and a coating layer formed on the surface. The coating layer has a compressive stress created therein. The coating layer is made of nano-scale crystalline particles and nano-scale crystalline boundaries. The nano-scale crystalline particles are enclosed and bordered by the nano-scale crystalline boundaries. The overall coating layer has an approximate thickness in the range from 20 nm to 200 nm. The surface is advantageously made of a tungsten carbide (WC) ceramic (e.g., WC or WC composite); and the coating layer is made of a material selected from a group consisting of SiC, Si₃N₄, TiN, BCN and any combination thereof.

An advantage of the present mold is that the thin film coating exhibiting a compressive stress has better fracture toughness than conventional mold surfaces, in operation.

Another advantage is that the thin film coating is more wear resistant and generally has a longer operating lifetime.

### BRIEF DESCRIPTION OF THE DRAWINGS

The above-mentioned and other features and advantages of the present mold and its method of manufacture, and the manner of attaining them, will become more apparent and the invention will be better understood by reference to the following description of its embodiments taken in conjunction with the accompanying drawings.

FIG. 1 is a schematic, cross-sectional view of an optical element mold, according to one embodiment; and

FIG. 2 is a schematic view of a vacuum system for conducting a bias radio frequency (RF) sputtering process for making an optical element mold, according to another embodiment.

Corresponding reference characters indicate corresponding parts throughout the several views. The exemplifications set out herein illustrate at least one preferred embodiment of the invention, in one form, and such exemplifications are not to be construed as limiting the scope of the invention in any manner.

### DETAILED DESCRIPTION OF PREFERRED EMBODIMENTS

Reference will now be made to the drawings to describe the preferred embodiments of the present mold and the manufacture thereof, in detail.

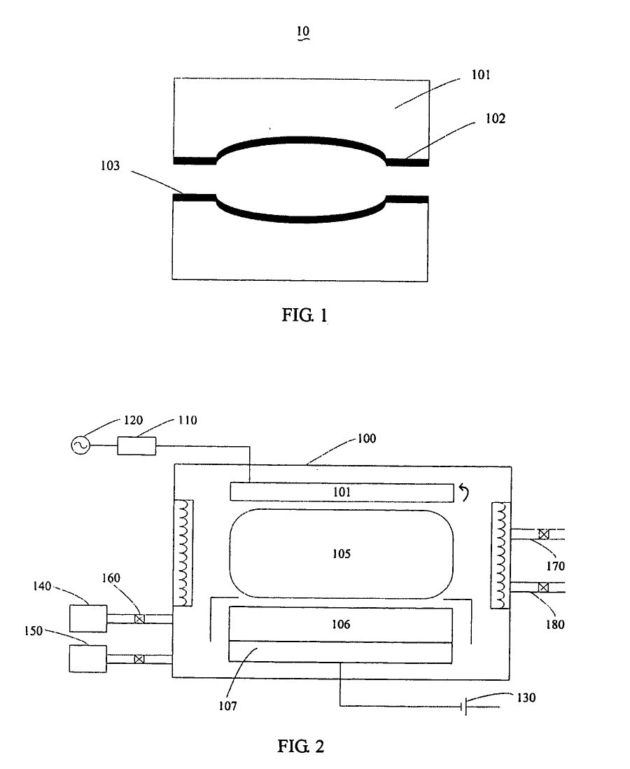

Referring now to the drawings, and more particularly to FIG. 1, there is shown an optical element mold 10, according to one embodiment. The optical element mold 10 has a mold base 101 and a coating layer 103 formed on a surface layer 102 of the mold base 101. The surface layer 102 is advantageously made of a tungsten carbide (WC) ceramic (e.g., WC or a WC-based composite). However, it is to be understood that any other carbide ceramic or other ceramic material that would promote the formation of a coating layer 103 having the desired properties would be within the scope of the present invention.

The coating layer 103 is substantially comprised of nano-scale crystalline particles enclosed and bordered by nano-scale crystalline boundaries (i.e., coating layer 103 being a polycrystalline material with both nano-scale grains and grain boundaries). The coating layer 103 has a thickness about in the range from 20 nm to 200 nm and preferably about from 50 nm to 100 nm. The coating layer 103 advantageously has an internal compressive stress created therein. A magnitude of the internal compressive stress depends on different materials used for forming the coating layer 103. The compressive stress is preferably configured within a range of about 3% to 9% of Young's modulus of the given material selected for use in the coating layer 103.

The optical element mold 10 is obtained by performing the following steps: preparing a mold base 101 having a surface layer 102 made of a WC ceramic; forming on the surface layer 102 a coating layer 103 with a compressive stress built up therein; and rapid thermal annealing the surface layer 102, together with the coating layer 103, so as to homogenize the crystalline structure of the layer 103 thereby improving the physical and chemical properties of the coating layer 103.

The coating layer 103 is made, usefully, of a material selected from a group consisting of silicon carbide (SiC), silicon nitride (Si₃N₄), titanium nitride (TiN), boron carbon nitride (BCN) or any combination thereof.

In order to create a compressive stress in a coating layer 103, a bias reactive sputtering process may advantageously be performed. FIG. 2 schematically illustrates a vacuum system for performing a bias reactive sputtering process, according to an exemplary embodiment associated with the production of the present mold. The vacuum system includes a vacuum chamber 100, a mold base 101 to be coated; a radio frequency (RF) power supply 120 connected to the mold base 101; a matching network 110 connected with the RF power supply 120; a target 106; a rough pump 150, a vacuum valve 160, a high-vacuum pump 140, a direct current (DC) power supply 130, a first mass flow rate controller (MFC) 170, and a second MFC 180.

In operation, the coating process includes a series of steps. A mold base 101 and a target 106 arranged opposite therefrom are disposed in the vacuum chamber 100. The vacuum chamber 100 is initially evacuated using the rough pump 150. The vacuum valve 160 is then opened, allowing the high-vacuum pump 140 to further evacuate the vacuum chamber 100 to obtain a base pressure of up to 5×10⁻⁷ Torr. Upon achieving the desired base pressure, a rare gas (for example, argon gas) is introduced into the vacuum chamber 100 via the first MFC 170. Simultaneously, a reactive gas, for example, nitrogen gas, is provided into the vacuum chamber 100 via the second MFC 180.

A negative bias potential, in the approximate range between −40V to −100V, is applied to the mold base 101 by the RF power supply 120, provided via the matching network 110. At the same time, a high negative potential is applied to the target 106 by the DC power supply 130. Due to the large potential difference created, a plasma 105 is formed, resulting from the ionization of the atoms of the reactive gas within an intense electric field. The ionization of the reactive gas produces a plurality of pairs of a negatively charged electron and a positively charged ion, the plasma itself thereby retaining a net neutral charge. The positively charged ions are attracted to the negatively charged target 106 and are accelerated by the electric field, so as to ultimately collide with the target material. The bombardment of the target 106 with these high energy ions leads to sputtering of the target atoms. The target atoms react with the ionized atoms of the reactive gas and form a coating on the mold base 101. Provided that the mold base 101 has a surface layer 102 made of a WC ceramic thereupon, the target 106 is a silicon target, and the reactive gas is nitrogen, a Si₃N₄ coating layer 103 with a compressive stress created therein is then formed on the WC surface layer 102.

The coating layer 103 can potentially be made of a material selected from a group consisting of silicon carbide (SiC), silicon nitride (Si₃N₄), titanium nitride (TiN), boron carbon nitride (BCN) and any combination thereof. Different materials adopted for forming the coating layer 103 generally result in corresponding different magnitudes of compressive stress. For instance, as for SiC, the range of the compressive stress is from 5×10⁵ to 3×10⁶ psi; as for Si₃N₄, the range of the compressive stress is from 5×10⁵ to 2×10⁶ psi; as for TiN, the range of the compressive stress is from 3×10⁵ to 1×10⁶ psi; as for BCN, the range of the compressive stress is from 5×10⁵ to 2×10⁶ psi; as for SiC+Si₃N₄, the range of the compressive stress is from 5× to 3×10⁶ psi; and as for TiN+Si₃N₄, the range of the compressive stress is from 5×10⁵ to 2×10⁶ psi (all such ranges given are intended to be approximate, the scope of such ranges being determined with this in mind). In order to obtain a predetermined value of the compressive stress in the coating layer 103, the negative bias potential applied to the mold base 101 by the RF power supply 120, via the matching network 110, may be correspondingly adjusted. The negative bias potential is generally selected to be about within the range from 40 V to −100 V. The greater the absolute value of the negative bias potential is, the greater the created compressive stress generally is.

It is to be noted that the foregoing bias reactive sputtering process is exemplified herein for illustrative purposes only. A variety of conventional methods, such as a co-sputtering process or a chemical vapor deposition (CVD) process, could instead be used for creating a coating layer 103 which would exhibit a compressive stress. Accordingly, any such method, which yields a coating layer 103 having the desired properties, may be suitably adopted and be considered within the scope of the present invention.

After a mold having a coating layer 103 that exhibits a compressive stress is obtained, a rapid thermal annealing process is advantageously performed upon the surface layer 102, together with the coating layer 103, so as to homogenize the crystalline structure of the layer 103, thereby improving the physical and chemical properties of the coating layer 103. The rapid thermal annealing process is preferably performed at a temperature in the range about from 250° C. to 500° C. in a vacuum environment for about from 30 seconds to 90 seconds.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An optical element mold comprising:
a mold base having a base surface; and
a coating layer formed on the base surface, said coating layer exhibiting a compressive stress therein, said coating layer being comprised of nano-scale crystalline particles and nano-scale crystalline boundaries, the nano-scale crystalline particles being enclosed and bordered by the nano-scale crystalline boundaries, said coating layer having an approximate thickness in the range from 20 nm to 200 nm.

2. The optical element mold as described in claim 1, wherein said coating layer is comprised of SiC.

3. The optical element mold as described in claim 2, wherein said compressive stress is in the range from is from 5×10⁵ to 3×10⁶ psi.

4. The optical element mold as described in claim 1, wherein said coating layer is comprised of Si₃N₄.

5. The optical element mold as described in claim 4, wherein said compressive stress is in the range from is from 5×10⁵ to 2×10⁶ psi.

6. The optical element mold as described in claim 1, wherein said coating layer is comprised of TiN.

7. The optical element mold as described in claim 6, wherein said compressive stress is in the range from is from 3×10⁵ to 1×10⁶ psi.

8. The optical element mold as described in claim 1, wherein said coating layer is comprised of BCN.

9. The optical element mold as described in claim 8, wherein said compressive stress is in the range from is from 5×10⁵ to 2×10⁶ psi.

10. The optical element mold as described in claim 1, wherein said coating layer is comprised of SiC+Si₃N₄.

11. The optical element mold as described in claim 10, wherein said compressive stress is in the range from is from 5×10⁵ to 3×10⁶ psi.

12. The optical element mold as described in claim 1, wherein said coating layer 102 is comprised of TiN+Si₃N₄.

13. The optical element mold as described in claim 12, wherein said compressive stress is in the range from is from 5×10⁵ to 2×10⁶ pSi.

14. The optical element mold as described in claim 1, wherein each nano-scale crystalline particle is of a size in the approximate range from 10 nm to 100 nm.

15. The optical element mold as described in claims 1, wherein said coating layer after being deposited on said substrate surface is treated by a rapid thermal annealing process.

16. The optical element mold as described in claim 1, wherein said base surface is comprised of a WC ceramic.

17. The optical element mold as described in claim 1, wherein said coating layer is made of a material selected from a group consisting of SiC, Si₃N₄, TiN, BCN and any combination thereof

18. A process of forming a mold configured for use in making an optical element, the process comprising the steps of:
preparing a mold base having a surface layer comprised of a carbide ceramic;
creating on the surface layer a coating layer, the coating layer exhibitinga compressive stress therein, the coating layer being a polycrystalline material with nano-scale grains and nano-scale grain boundaries; and
rapid thermal annealing the surface layer, together with the coating layer.

19. The process as described in claim 18, wherein the rapid thermal annealing step is performed, at a temperature in the approximate range from 250° C. to 500° C. in a vacuum environment for about a period of time of from 30 seconds to 90 seconds.
